(19) United States
(12) Patent Application Publication
(10) Pub. No.: US 2018/0341891 A1
(43) Pub. Date: Nov. 29, 2018

(54) TASK MONITORING

(71) Applicant: Spot You More, Inc., Raleigh, NC (US)

(72) Inventors: Joel R. Setchell, Advance, NC (US); James D. Haley, Winston-Salem, NC (US)

(21) Appl. No.: 15/987,522

(22) Filed: May 23, 2018

Related U.S. Application Data
(60) Provisional application No. 62/511,307, filed on May 25, 2017.

(51) Int. Cl. G06Q 10/06

(52) U.S. Cl. CPC G06Q 10/06311

(57) ABSTRACT

A system for monitoring tasks of personnel in a convenience store. The system may include sensors for measuring product and cleanliness characteristics and assigning tasks to employees. The tasks may be scheduled based on regular intervals. The tasks may be generated in response to data monitored by the sensors. Further, the sensors may be used for verification of task completion.

### CROSS REFERENCE TO RELATED APPLICATIONS

This application claims the benefit of U.S. Provisional Patent Application No. 62/511,307 filed May 25, 2017, the content of which is hereby incorporated by reference in its entirety.

### BACKGROUND

### 1. Field of the Invention

The present invention generally relates to task monitoring.

### 2. Description of Related Art

Convenience stores, especially stores attached to gas stations, are trying to increase revenue and store traffic. Often convenience stores, especially those attached to a gas station, are often used for eating and restroom breaks by travelers. These convenience stores also include a great variety of products and services which may present challenges in properly training and monitoring employees over the large number of required tasks.

### SUMMARY

The present disclosure describes a system for task monitoring, for example at a convenience store.

Various sensors may be used to monitor various processes, products, systems, devices and equipment within a gas station/convenience store. The sensors and system may identify certain conditions that require action by personnel, such as store clerks, managers, maintenance people, etc. The sensors and system may identify certain conditions that require action by the system, device, product and equipment manufacturer or vendor. The measured conditions may include an element such as the length of time such a condition has existed, and calculate impact of the condition (for example, refrigerator door left open 10 minutes=$2 is energy lost). The measured conditions may include the ability to deploy a coupon. As an example, the temperature of the refrigerator where beverages are merchandised is 34° F., this information may be included in a communication to the consumer with a coupon. The measured conditions may alert store personnel, a product manufacturer, or distribution center of inventory levels. The measured conditions may further enable automated replenishment orders to a manufacturer or distribution center. The sensors may also verify when such a task has been completed by the personnel. For example, if a sensor identifies that a refrigerator is open, the system may receive a confirmation that the appropriate personnel was notified of the task, and the system may record the amount time that it takes for the personnel to complete the task (for example, closing the door).

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system for task monitoring.

FIG. 2 is a block diagram of a system for task monitoring.

FIG. 3 is an illustration of a mop assembly for cleanliness monitoring.

FIG. 4 is an illustration of a database for one implementation of a task monitoring system.

FIG. 5 is an illustration of a display for a task monitoring system.

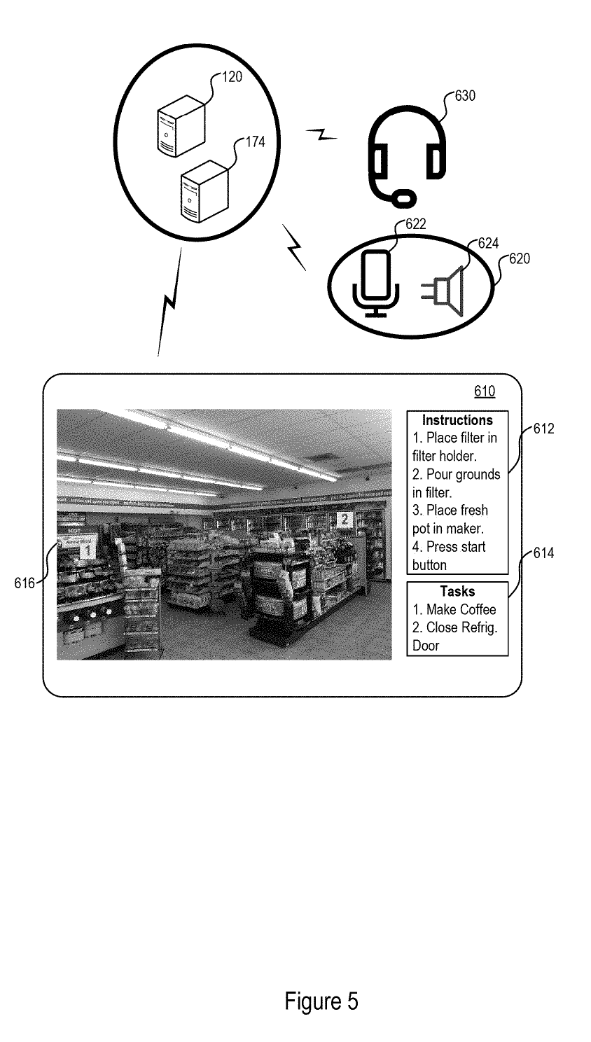

### DETAILED DESCRIPTION

Personnel in a store may have to monitor and complete a wide variety of tasks in a very busy environment. With expanding hot food and beverage offerings in convenience stores, tracking and verifying tasks is becoming more important. Sensor and point of sale information can provide important indicators of when and how well tasks are being accomplished. Sensors may be used in conjunction with retail locations such as convenience stores and gas stations. The sensors may be in and around the store. For example some sensors maybe located at fixed locations within the stores or may be attached to or integrated within certain devices within the store. Sensors may be located in equipment such as the freezer, refrigerator, heater/oven, coffee maker/dispenser, in perishable food areas where temperature and humidity may be monitored to ensure quality of food. The devices may be moveable within the store, such as cleaning devices, such as mops or vacuum cleaners which employees may use to maintain store cleanliness. The sensors fixed within the stores may also interact with the devices to provide location of the devices within the store. Sensors attached to or integrated within the devices may provide information regarding the use of the device and/or location of the device. Further, information may be provided that relate the usage characteristics to one another or time intervals to interpret how the device is being used. The analysis may compare usage of the device to proper usage characteristics. Analysis of the usage may be based on defined logic and thresholds defined within the device, a local server, or a cloud based analytics platform. The local server or analytics platform may house the data pushed up from the sensor devices and notification alerts may be triggered based on certain events. Certain data may be distributed by the server to relevant stakeholders based on a defined frequency or immediately based on certain conditions being met.

The system may generate, collect and monitor data related to tasks assigned to personnel. The data may include notification of a task, accepted task employee ID, accepted task time, presentation of task location (e.g. on a map), presentation of task description/check list, assistance notification, notification from personnel that the task has been completed, confirmation from sensor system that the task has been completed, feedback from store manager regarding quality of performed tasks, incentives provided to consumers to provide quality feedback related to tasks, ratings for particular personnel (e.g. based on time to start tasks, time to complete tasks), quality feedback of tasks (consumers/store manager, product manufacturers, OEM equipment manufacturers), notification to inform store manager if time to complete task has exceeded a threshold time, notification to inform store manager if quality feedback of task is below threshold, rating for particular personnel based on time to start tasks, time to complete tasks, quality feedback of tasks (consumers/store manager), seek feedback from consumers regarding quality of tasks, provide incentive to consumers to provide quality feedback, provide rating for stores as a combination of the personnel assigned or currently working at a store.

Data may be collected by the smart sensors and pushed to the cloud to be analyzed. Such data may include, but may not be limited to: current temperature, changes in temperature, motion/position data (e.g. cooler or heat-oven opened/closed and how often), and humidity levels. Data collected by the sensors may include OEM Food equipment and supplies, Food equipment temperature, inventory, general status (e.g. routine maintenance/cleaning), Beverage equipment temperature, inventory, general status, and Food & Beverage accoutrements: cups, plates, bowls, serving containers, napkins, plasticware, etc., as well as, General merchandise inventory levels. The data may also include, but may not be limited to: bathroom throughput (# of people entering, and exiting), time between entry, length of visit (dwell time), mop location, mop movement including duration and form, mop physical characteristics including saturation (wetness) and head quality (does mop head need to be changed). Further, other smart sensors may also monitor soap level, water level in toilet, water level on floor, paper towel supply, and toilet paper supply.

The relevant stakeholder groups that will receive notification alerts and/or data include, but may not be limited to store clerks, store managers, CPGs, consumers, and equipment OEMs. As a general rule, each notification trigger and data distribution set discussed in this disclosure can be mapped (one to one [1-1] and/or one to many [1-n]) to each of the delivery channels/mechanisms discussed.

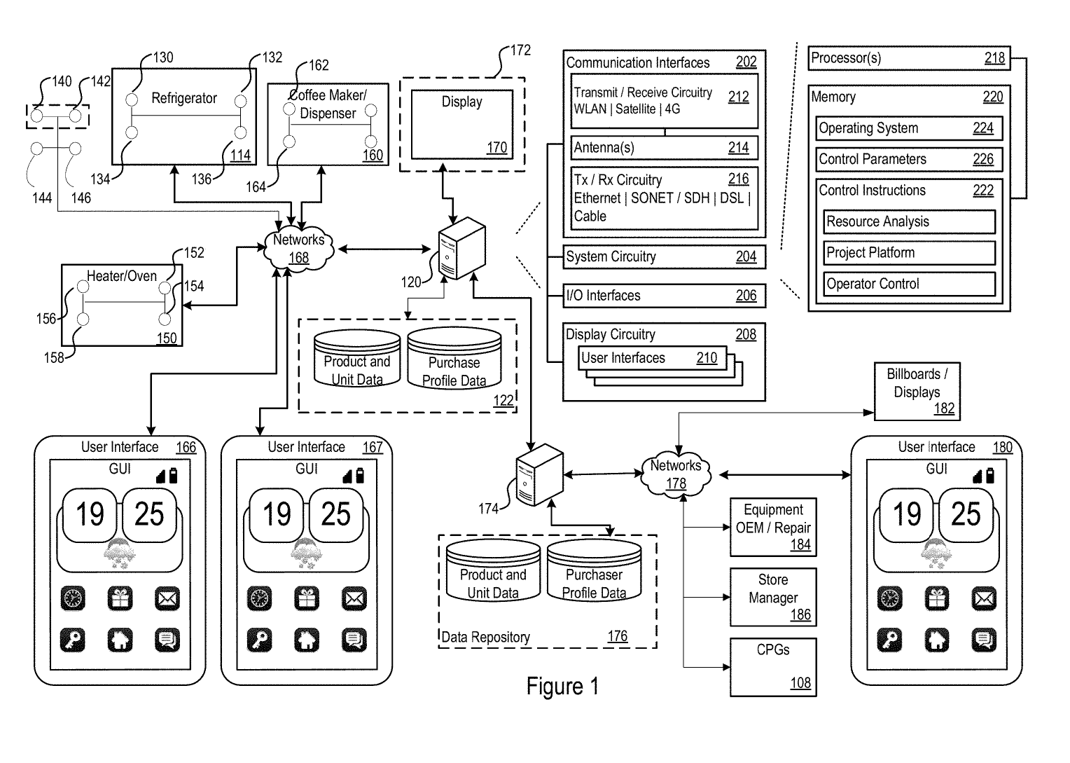

FIG. 1 is a block diagram of a system 100 for monitoring of one or more products. The system may include a number of sensors monitoring products and equipment at a retail location such as a convenience store. Although the system may interact with multiple sensors at multiple convenience store locations simultaneously. The sensors may be smart sensors and therefore may receive and/or send data to a monitoring production server either directly or through a hub.

A smart sensor may include a processor. A processor may allow the sensor to sample and transmit data upon receipt of a command to do so and/or continuously sample data to provide a continuous stream of data with regard to the characteristic being monitored, and evaluate if the data exceeds certain defined thresholds and send an alert in response to the monitored characteristic exceeding one or more thresholds. The alert may include and alert classification as well as the monitored data. The processor may also provide for the measurement unit to be calibrated and/or reset at the location of the sensor or remotely from a server. The sensor may include a display and/or end-user interface (e.g. buttons or switches, etc.) for setting and reviewing real time data as well as setting and monitoring alert information or threshold information. The sensors may monitor characteristics related to cleanliness, such as usage, frequency of usage, water levels, availability of cleanliness related products. The sensors may also monitor characteristics of products stored in a product preparation or dispensing unit (e.g. temperature, humidity, time) or characteristics of the preparation and dispensing unit itself (power, doors open/closed, temperature, humidity, time, amount of product contained, etc.). Alerts and/or tasks may be generated in response to any of the product or unit characteristics noted herein, either based on a threshold or a comparison with other product or unit characteristics. Alerts and or tasks may also be generated in response to any of cleanliness related characteristics noted herein, either based on a threshold or a comparison with other cleanliness characteristics.

The sensors may monitor characteristics of one or more refrigerators 112. The first refrigerator 114 may include a temperature sensor 130 that is located in close proximity to the products and the refrigerator. As such, the temperature sensor 130 may provide a measurement of the temperature of the product. For example, the product may be various items that are stored in a convenience store refrigerator. Such items may include but are not limited to water, soft drinks, juices, and other beverages as well as various food items. Sensor 132 may be a humidity sensor located approximate products in the refrigerator. As such, the sensor 132 may measure the humidity at the container of the product. The refrigerator 114 may include one or more additional temperature sensors 134 located away from the product, for example, near the door. In comparison between the sensor 130 and the at least one sensor 134 the system may determine various information about the refrigerator system. For example, alert may be set to indicate that the refrigerator door is opened based on a temperature difference between the product 130 and the temperature sensor 134.

In other implementations, the difference between the sensor 130 and the sensor 134 may be used to determine if the refrigeration is operational and functioning properly. Based on analysis over time, a comparison may also provide information about energy usage of the refrigerator and/or whether the refrigerator is performing to operational specifications. If the refrigerator is not operating to its operational specifications according to the monitoring data of the sensors individually or in combination an alert may be sent to various parties including the store manager, a corporate monitoring entity, and/or an equipment manufacturer and/or repair facility. In addition, other sensors may be provided in the refrigerator including a door position sensor 136 to determine if a door is opened or closed and the frequency of the door opening and closing. The refrigerator may also include a sensor to determine the amount of product on the shelves using a position sensor, an optical scanning sensor, or a weight sensor. Alerts may be generated based on the amount of product in the refrigerator when compared to a fill threshold. The store clerk may be notified to restock or manufacturers may be notified to order more product.

Alerts may be generated based on measured cleanliness characteristics. The store clerk may be notified to restock or perform maintenance tasks. This information may also be used to generate electronic coupons or in store advertisements in response to the measured characteristics, for example the amount of a particular product that is available. (e.g. if it is below a threshold offers such as discounts may be given to sell the last one, alternatively if it is fresh offers may be generated informing consumers of fresh product.) Data from these sensors may be communicated to a router or server 120 via a network 118. The network may be a wired network and/or a wireless network. As such, the sensors may include a wireless transmitter to connect to the server 120 via a wireless network such as Wi-Fi, BlueTooth, etc.

The system 100 may also include sensors for measuring ambient temperature or humidity. For example, the system may include a temperature sensor 140 located outside of the convenience store but on the convenience store property as denoted by reference numeral 138. In addition, the system may include a humidity monitor 142, sensors 140-142 may provide information about the outside weather conditions and the area surrounding the convenience store. In addition, the system 100 may include a temperature sensor 144 and a humidity monitor 146 within the convenience store to monitor the temperature and humidity conditions inside of the convenience store that may affect performance of other equipment for example the refrigerators 112, or other devices such as ovens, heaters, coffee makers, or other food and beverage preparation and/or dispensing devices.

The system 100 may also include a temperature sensor 152 connected to monitor the temperature of an oven/heater device 150 used for food preparation and/or dispensing in a convenience store. Temperature sensor 152 may be located approximate product to measure a temperature of the product. The product may include heated beverages or food. Food may be a pizza in a pizza oven, or hot dogs, and/or sausages on a roll cooker. A position sensor 154 may also be provided to monitor the opening or closing of a door or access generally to the oven or heater. As such, the system can determine the frequency and duration at which the door was open and the effects on the temperature of the product and/or alert if the temperature of the product exceeds certain thresholds or if the access to the heater or oven is left open for longer than a certain duration. It is also understood that multiple temperature sensors may be used to determine access to the heater or oven as well as functioning of the heater or oven in a manner described above with respect to the refrigerator 114.

The heater/oven may also include a humidity sensor 156 and a sensor 158 to determine the amount of product on the shelves. The amount of product may be determined using a position sensor, an optical scanning sensor, or a weight sensor. Alerts may be generated based on the humidity or the amount of product in the heater/oven when compared to a fill threshold. The store clerk may be notified to restock or manufacturers may be notified to order more product. This information may also be used to generate electronic coupons or in store advertisements in response to the amount of a particular product that is available. (e.g. if it is below a threshold offers such as discounts may be given to sell the last one, alternatively if it above a threshold offers such as discounts or notifications may be generated informing consumers of fresh product.) .

In addition, the temperature sensor 162 may be provided with respect to measuring the temperature of coffee in a coffee maker or storage unit 160. A fill sensor 164 may determine whether the coffee maker or storage unit is filled with coffee. The threshold limit may be set to alert the server 120 if the coffee fill level is below a certain level. The coffee maker may also include a position sensor to track access to the amount of times the coffee has been accessed and provide an alert to the server 120 if the coffee has been accessed for a threshold limit of time, and/or a threshold number of times, and/or a threshold frequency within the given time period.

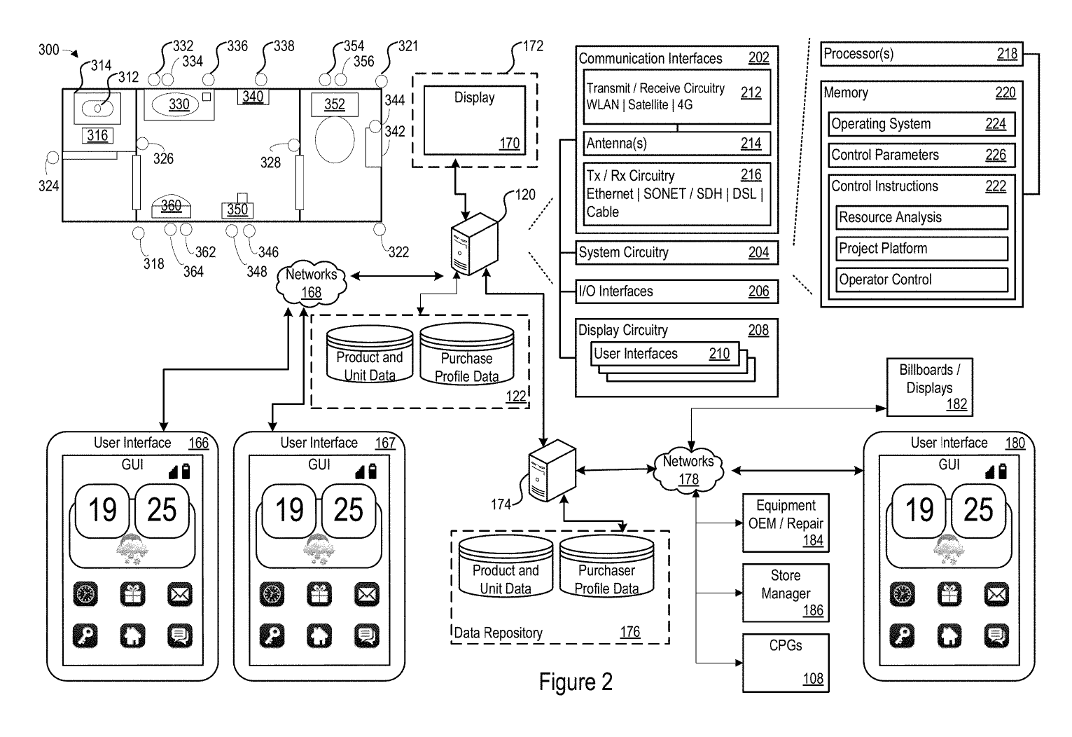

FIG. 2 is a block diagram of a cleanliness monitoring system 300. The system 300 may include a mop 312, a charging station 313, a bucket 316, and a number of other sensors in communication with a server 320. The system may include a number of sensors monitoring different cleanliness characteristics at a retail location such as a convenience store. In one example, a restroom of a convenience store is monitored by the system 300.

Smart sensors, for example infrared proximity sensors, may be placed on the wall of the bathroom. Sensors may connect to a smart mop and embedded accelerometer via Bluetooth Low Energy (BLE) signal. Sensors may collect data on the number of patrons entering and exiting the bathroom, and may also monitor when, how frequently, and for how long the bathroom has been mopped. Other use cases beyond this baseline are explored in the below document (e.g. Soap levels, Water level in toilet, Water level on floor, Paper towel supply, Toilet paper supply).

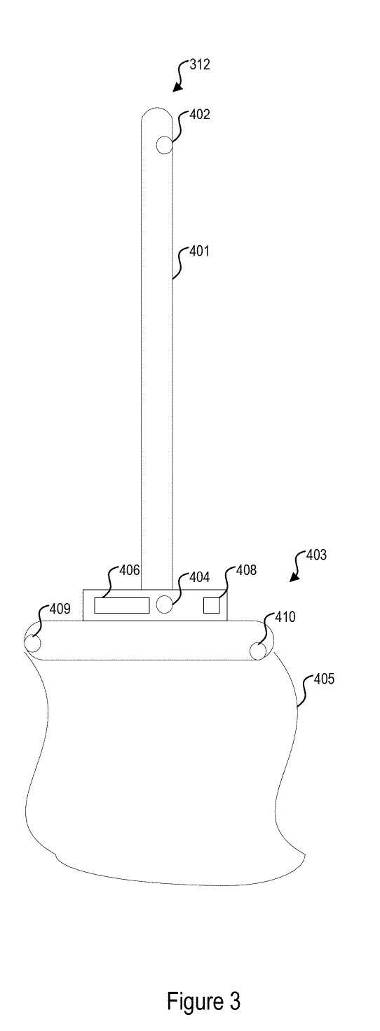

FIG. 3 illustrates additional detail of the mop 312. The mop 312 includes a handle 401 extending from a mop head assembly 403. The mop head assembly 403 may include a replaceable mop head material 405 that may be changed due to wear and damage over the life of the mop 312. Mop head assembly 403 may also include a processor 406 and multiple sensors. The mop head assembly may include a motion sensor 404 to detect and/or characterize the movement of the mop 312 during usage. The motion sensor 404 may include one or more accelerometers to identify the motion of the mop 312 along multiple axes, for example one axis along the handle and two axis perpendicular to the handle. Further, the motion sensor 404 may include a gyroscope or other angular sensors to determine the orientation of the mop 312 during its use. As such, the processor 406 may analyze the motion characteristics of the mop including for example, acceleration, velocity, tilt, pressure, or other characteristics to determine whether the mop is being used properly. Such determination may be based on various thresholds with regard to one or more of the motion characteristics and/or comparison with a template motion profile over time to determine if the actual motion of the mop matches or is similar to a predetermined motion profile. In some examples, similarity may be determined by a threshold of the correlation between the actual motion and the predetermined motion profile.

Further, the processor 406 may be in communication with pressure sensor 409 and moisture sensor 410. Pressure sensor 409 may provide a signal indicating the amount of pressure being put on the mop head material 405 through the handle 401. Moisture sensor 410 may determine whether the mop head material 405 has been saturated for example, placed in a bucket full of water and/or soap to conduct the mopping. As such, the motion of the mop from sensor 404, the pressure applied to the mop 409 and the moisture of the mop head material from sensor 410 may be used in conjunction to determine proper usage of the mop due to thresholds on each of those characteristics and/or in comparison to various stored usage profiles. If improper usage is determined the task may generated again and a notification may be provided to a store manager. Also, a satisfaction report may be generated and used to rate the personnel that performed the task.

The mop 312 may include a power interface 408. The power interface 408 may include a connector that may provide power to the processor and sensors within the mop 312. Further, the power interface 408 may include a battery to store power for the processor and sensors during use. The power interface 408 may allow for direct contact to convey the power or may use a wireless charging technology for example inductive charging such that direct contact with the mop is not required to perform charging activity. In some implementations, the charging interface 408 may include a photocell allowing the battery to be charged using light energy that is projected onto a photo panel and stored in a battery for later use by the processor and sensors.

The processor 406 may also control a transmitter 402. The transmitter 402 may communicate information about the motion of the mop, pressure applied to the mop, and/or moisture of the mop head to a server remote from the mop 312. The processor 406 may transmit raw data from the sensors and/or may reduce the data transmitted by applying thresholds and/or profile comparisons prior to them transmitting the results of the thresholds and/or comparisons or alerts if the thresholds or comparisons are exceeded or beyond a predetermined value or frequency. In addition, the transmitter 402 may be used in conjunction with sensors within the retail location to determine a position of the mop 312 within the retail location.

Referring again to FIG. 2, the charging station 314 may be provided to interface with the mop 312. The charging station 314 may include a power interface such as a connector or inductive wireless charging panel to inner provide power to the power interface of the mop 312. The mop 312 may be used with a bucket 316. In some implementations, the bucket 316 may include a processor and transmitter to identify the position of the bucket 316 with regard to sensors placed within the retail location. Further, the bucket 316 may include a moisture sensor and/or a fill level sensor to identify that the bucket 316 is properly filled when used in conjunction with the mop 312. The mop 312, the charging station 314, and the bucket 316 may be stored in a closet which may be near a restroom facility. The closet may include a door and a sensor 324 may be positioned to interface with the door to determine when the door is opened or closed. The opening and closing of the door as determined by sensor 324 may be indicative of the mop and bucket being accessed and may be used by a cleanliness monitoring server to trigger certain monitoring activities and/or satisfy certain action requests. The sensor 324 may be proximity, displacement, motion, or other sensor configured to identify the opening and closing of the door.

Similarly, sensor 326 may monitor the opening and closing of a bathroom door providing access to the bathroom from the retail area of the store. Sensor 326 may be used to determine a mount and/or frequency access to the bathroom. In addition, sensor 328 may be configured to determine whether a door to a stall is opened or closed and as such may be used to determine the number of accesses and/or frequency of access to a particular stall in a particular bathroom. Sensors 326 and 328 may be proximity, displacement, motion, or other sensor configured to identify the opening and closing of the door.

As the mop 312 and/or bucket 316 is moved into the restroom, sensor 318 may communicate with the transmitter for example, transmitter 402 of mop 312, to determine a location of the mop. In one implementation, the strength of the transmitted signal may be used to determine the proximity with regard to sensor 318 and if the proximity is within a certain distance based on signal strength, the mop will be determined to have entered the restroom. In another implementation, multiple sensors may be used to determine the location of the mop and/or bucket within the restroom using the signal strength and/or other signal characteristic to triangulate a position of the mop within the restroom. For example, the sensor 318 may be positioned within a first location, for example, a first corner of the room. A second sensor 321 may be positioned in a second position, for example, a second corner of the room opposite from the first sensor 318. A third sensor 322 may be located in a third position for example, a third corner of the room. Each of the sensors may communicate with the transmitter 402 of the mop 312 to determine a position of the mop and based on the comparison between signal characteristics received by each sensor 318, 321, 322, the position of the mop with regard to each of the sensors may be determined for example, by a triangulation method.

In addition, a sink 330 may be located in the restroom. The sink may include a number of sensors to monitor various characteristics of the sink. For example, sensor 332 may measure use of the sink. For example, sensor 332 may be a proximity sensor to determine when a person has put their hands under the faucet and/or when the person's body has moved close to the sink counter. In some implementations, the sensor 332 may be a water flow sensor to determine that the water is flowing from the faucet. Further, an overflow sensor 334 may be provided to determine if the water level in the sink has exceeded a predetermined threshold. In addition, a fill sensor 336 may monitor the usage and/or amount of soap provided in a soap dispenser located proximate the sink. The fill sensor may be a weight sensor, or a proximity sensor, or displacement sensor configured in a manner to determine an amount of soap used from and/or remaining in the soap dispenser. In addition, a towel dispenser 340 may be provided in the restroom. The sensor 338 may be provided to monitor the amount of towels available in the towel dispenser 340. The sensor 338 again, may be a weight, proximity, displacement, or other sensor configured to measure the amount of towels remaining and/or the amount of towels that have been used from the towel dispenser 340. In addition, a toilet paper dispenser 342 may be provided in a stall of the restroom in a sensor 344 may measure the amount of toilet paper used and/or left available in the toilet paper dispenser 342. Again, the toilet paper dispenser may be a weight sensor, proximity sensor, or displacement sensor configured to measure the amount of toilet paper in the dispenser 342.

The restroom may also include a hand dryer 350. The hand dryer 350 may include a sensor 346 to determine the activation of the hand dryer 350. The sensor 346 may be used to determine the number and/or frequency of activations of the hand dryer 350. Further, a temperature sensor 348 may be used to determine the temperature of the air being blown the hand dryer 350.

The bathroom may include a toilet 352. The toilet 352 may include a sensor 354 which may be used to determine the activation or flush of the toilet as such, the sensor 354 may be used to determine the number of flushes and/or the frequency of the flushing of the toilet. In addition, the sensor 354 may be used to determine if the toilet 352 is continuously flushing due to a stuck handle and/or other defective mechanism. Further, a fill sensor 356 may measure the water level in the toilet bowl and/or tank to determine whether an overflow scenario has occurred.

The bathroom may include a toilet 360. The toilet 360 may include a sensor 362 which may be used to determine the activation or flush of the toilet as such, the sensor 362 may be used to determine the number of flushes and/or the frequency of the flushing of the toilet. In addition, the sensor 362 may be used to determine if the toilet 360 is continuously flushing due to a stuck handle and/or other mechanism. Further, a fill sensor 364 may measure the water level in the toilet bowl and/or tank to determine whether an overflow scenario has occurred.

Upon receiving the data from the sensors the server 120 may store the data locally in a storage device 122. The server may also analyze the data and determine certain thresholds based on the characteristics of the sensor exceeding a certain value, or based on the comparison between various sensors, or based on an alert provided from a particular sensor the server 120 may communicate with a mobile device 166 that may be configured with an application for notifying a store clerk with an action needed to be taken with regard to maintenance or restocking. In addition, the server 120 may communicate with a mobile device 167 from a consumer based on an application loaded on the mobile device 167.

The application may allow the user to receive communication from a local network within the store 110. The application may allow the mobile device 167 to provide a user interface to present offers and/or electronic coupons to the consumer in response to the characteristics monitored by the smart sensors and/or a comparison of the smart sensors and/or a comparison of the monitored data with a threshold. In addition, the server 120 may be in communication with a display device 170 located within the store or on the store grounds as noted by box 172. The display 170 may be a public display, for example, a monitored unit or sign display to provide an offer or message to a consumer in response to food preparation or cleanliness information. The server 120 may communicate with an external server 174 located in a remote location such as corporate headquarters. The server 174 may receive data from the server 120. The server 120 may push the data to the server 174 and/or, the server 174 may request the data from the server 120. The data may be streamed in real time to the server 174 or accumulated and provided in batches, for example, after the store is closed or in the late evening hours. Further, certain data may be provided at different times based on a data priority. For example, alerts that a characteristic exceeded a certain threshold may generate a message that is immediately transmitted from server 120 to server 174 whereas the actual monitored data may be transmitted at a later time as a different priority. The data that the server 174 may be stored in a data storage unit 176 and may be retrieved by server 174 or other servers for additional data analysis. The server 174 may communicate via a network 178 with various other devices. For example, server 174 may communicate with a billboard display 182. The billboard display may display the characteristics that are monitored by the sensors located on the product preparation or dispensing devices. In addition, the billboard display may display ambient temperature information from the store or from the remote sensor on the temperature billboard as a comparison with the temperature of the food product being monitored by the system. The billboard display may also include cleanliness, task information (e.g. bathrooms just cleaned, coffee just made fresh), or rating information to entice consumers to stop at the store.

The server 174 may communicate with an equipment OEM or repair facility 184. The server 174 may communicate with the equipment OEM or repair request system 184 to request maintenance, for example on a food preparation or dispensing system. Further the system 174 may generate an offer such as an electronic coupon and send the electronic coupon to a user device 180 based on the food characteristics (temperature, humidity) or cleanliness information and additional information including for example the user profile information stored on the server 174 or the remote device 180, the location information related to the electronic device 184 other factors.

Store Clerk

The store clerk may receive notifications for various situations. The determination to transmit the notification may be in the server 120 located in the store 110 and/or by the remote server 174. The store clerk may receive notifications on a mobile or display device through a local network via server 120. The store clerk may receive notifications on various devices through a wide area network via server 120 or remote server 174.

The system may generate, collect and monitor data related to tasks assigned to personnel. The data may include notification of a task. (via email, text, website, app, other smart device (e.g. name badge), voice to headset, etc., accept task employee ID, accept task time, presentation of task location, presentation of task description/check list, assistance notification, notification from personnel task has been completed, confirmation from sensor system that task has been completed, provide rating for particular personnel based on time to start tasks, time to complete tasks, quality feedback of tasks (consumers/store manager).

Product notifications may be triggered or tasks may be generated in response to various events such as, temperature in cooler exceeds (higher or lower than) a temperature threshold, temperature in heater/oven falls below temperature threshold, cooler door has been left open above time threshold, heater/oven door has been left open above time threshold, humidity in cooler exceeds temperature threshold, humidity in heater/oven falls below temperature threshold, outdoor temperature exceeds or falls below a certain threshold, cooler is due for maintenance, based on defined frequency, heater/oven/coffee maker or dispenser is due for maintenance, based on defined frequency, coffee needs to be brewed, coffee machine is failing/failed, fountain drink cups are out of stock, hot dogs need restocking, CO2 tanks need replacement, general inventory restocking.

Cleanliness notifications may be triggered or tasks may be generated in response to various events such as, bathroom is due for mopping/cleaning, based on defined frequency, mopping/cleaning time, as scheduled, is missed, mop is out of place/not stored in defined location, mop head is due for cleaning, based on defined frequency, mop head is due for changing, based on defined frequency, water levels in toilet are above defined threshold, water levels on floor are above defined threshold (flooding), toilet paper levels are below defined threshold, soap levels are below defined threshold, paper towel supply is below defined threshold, toilet paper supply is below defined threshold, consumer throughput is above a defined threshold.

Individual notification triggers can be delivered via any or all of a POS system, Tablet App, Smartphone (App, SMS), Smartwatch (E-Mail), other wearable devices (E-mail, App, notification, SMS). General data may be distributed at the defined frequency, distributed based on a trigger or threshold being exceeded, and accessible any time in dashboard form via any or all of POS system, Tablet App, Smartphone (App, SMS link to Web landing), or voice command system.

Additional data sources that are potentially relevant for the store clerks may include Corporate systems (compliance info, updated process guidelines, other information), CPG systems (offer availability), POS data (consumer purchasing history). Potentially amended process/use case for store clerks may include updated compliance information being sent from corporate systems to the store and, in combination with data sent from sensor device(s), the store clerk amends the thresholds or dashboard reporting frequencies (or other compliance related metrics) that have been previously set. One process may include the clerk receiving alert when a regular product (e.g. Coca-Cola, tobacco products, etc.) purchaser (based on POS data history) enters the store. If the temperature is above a certain threshold, he/she will be prompted to open offer dashboard provided by CPG (Coca-Cola) system, check if an offer is available and, if so, volunteer to the consumer that the offer is available. Another process may include the clerk receiving alert when a purchaser particularly interested in cleanliness (based on profile or preference history) enters the store. If a cleanliness characteristic exceeds a certain threshold, he/she will be prompted to open offer dashboard provided by the system, check if an offer is available and, if so, volunteer to the consumer that the offer is available. In another implementation a work order related to the cleanliness characteristic may be issued in response to the purchaser entering the store. (e.g. a task generated to clean the bathroom)

Store Manager

The store manager may receive notifications for various situations. The determination to transmit the notification may be in the server 120 located in the store 110 and/or by the remote server 174. The store manager may receive notifications on a mobile or display device through a local network via server 120. The store manager may receive notifications on various devices through a wide area network via server 120 or remote server 174.

The system may generate, collect and monitor data related to tasks assigned to personnel. The data may include receiving assistance request from personnel attending to task, seek feedback from store manager regarding quality of tasks, provide incentive to consumers to provide quality feedback, provide rating for particular personnel based on time to start tasks, time to complete tasks, quality feedback of tasks (consumers/store manager), inform store manager if time to complete task has exceeded a threshold time, inform store manager if quality feedback of task is below threshold.

Product notifications may be triggered or tasks may be generated based on events such as, cooler maintenance, as scheduled, is missed, heater/oven/coffee maker or dispenser maintenance, as scheduled, is missed. Additional collected data from the sensors may be delivered at defined time/time interval(s) and analyzed for sending additional notifications based on a exceeding a threshold (upper, lower, or based on a comparison) of one or more of Average cooler temperature over defined time period, average heater/oven temperature over defined time period, number of notification triggers and their type (e.g. cooler temp fell below threshold x times in y hours), Time to corrective action, Door open and close frequency over defined time period, max temperature swing over defined period of time, map of sensors and their plotting across store, completed tasks over defined time period (maintenance, cleaning), average outside temperature, number of temperature driven CPG offers (e.g. coupons or electronic coupons) triggered—by product, over a defined period of time, number of temperature driven CPG rebates triggered—by product, over a defined period of time, coffee needs to be brewed, coffee machine is failing/failed, fountain drink cups are out of stock, hot dogs need restocking, CO2 tanks need replacement, general inventory restocking.

Cleanliness notifications may be triggered or tasks may be generated based on events such as, bathroom is due for mopping/cleaning, based on defined frequency, mopping/cleaning time, as scheduled, is missed, mop is out of place/not stored in defined location, mop head is due for cleaning, based on defined frequency, mop head is due for changing, based on defined saturation levels and/or frequency, water levels in toilet are above defined threshold, water levels on floor are above defined threshold (flooding), toilet paper levels are below defined threshold, soap levels are below defined threshold, paper towel supply is below defined threshold, toilet paper supply is below defined threshold.

Additional collected data from the sensors may be delivered at defined time/time interval(s) and analyzed for sending additional notifications or tasks generated based on a exceeding a threshold (upper, lower, or based on a comparison) of one or more of number of notification triggers and their type (e.g. toilet paper supply fell below threshold x times in y hours), time to corrective action, map of sensors and their plotting across bathroom unit(s), completed tasks over defined time period (maintenance, cleaning), average consumer throughput by bathroom unit, average consumer length of visit (dwell time), mop duration, across all scheduled cleanings, mop form, across all scheduled cleanings, average water level in toilets, average water level on floor, average paper towel supply volume, average toilet paper supply volume, average soap levels.

Individual notification triggers can be delivered via any or all of POS system, Tablet App, Smartphone (App, SMS), Smartwatch (App, SMS), Other wearable devices (E-mail, App, notification, SMS), Desktop PC (E-Mail, Web Landing Page), Laptop PC (E-Mail, Web Landing Page). General data may be distributed at the defined frequency, distributed based on a trigger or threshold being exceeded, and accessible any time in dashboard form via any or all of POS system, Tablet App, Smartphone (App, SMS link to Web landing), Smartwatch (App, SMS link to Web landing), Other wearable devices (E-mail, App, notification, SMS), Desktop PC (E-Mail, Web Landing Page), Laptop PC (E-Mail, Web Landing Page), or voice command system.

Additional data sources that are potentially relevant for the store managers may include Corporate systems (compliance info, updated process guidelines, other), CPG systems (offer availability), Store systems (clerk performance history), POS system (consumer purchasing history). Potentially amended process/use case for store managers may include updated compliance information being sent from corporate systems to the store and, in combination with data sent from sensor device(s), the store clerk amends the temperature, humidity, or cleanliness parameters (e.g. thresholds) that have been set. Another process may include generating information accessible in dashboard form for manager to pull down. For example based on temperature info provided by the sensor device, the manager may be presented with a interface to ‘activate’ an offer that is relevant in select stores for a certain period (e.g. if it is 90 degrees in the heat of summer, perhaps $1 off cold Coca-Cola makes far more sense than 50 cents off hot chocolate). Another process may include generating dashboard reports for sensor device, pushed to the manager at a defined frequency, that provide info, graphics, and/or alerts around sensor management and compliance can be a key data point that is used in combination with other clerk performance data to enhance the performance appraisal process.

CPGs

The CPGs or food service vendors may receive notifications for various situations. The determination to transmit the notification may be in the server 120 located in the store 110 and/or by the remote server 174. The CPGs or food service vendors may receive notifications on a mobile or display device through a local network via server 120. The CPGs or food service vendors may receive notifications on various devices through a wide area network via server 120 or remote server 174. In one example, the provider of hot dogs to a convenience store might want to know that its product is being maintained at optimal temperature for consumption. This would be helpful if the chain were to receive consumer complaints about the product, the hot dog provider would have data to show that its product is not the issue. Product notifications may be triggered or tasks may be generated based on events such as, Outdoor temperature exceeds or falls below temperature threshold (suggest to give offer), Cooler door has been left open above time threshold, Heater/oven door has been left open above time threshold, Inventory levels (above/below threshold), temperature levels (hot/cold items), delivery truck needs to be routed, additional order quantity added to store order.

Additional collected data from the sensors may be delivered at defined time/time interval(s) and analyzed for sending additional notifications based on a exceeding a threshold (upper, lower, or based on a comparison) of one or more of Average cooler temperature over defined time period, Average heater/oven temperature over defined time period, Number of notification triggers and their type (e.g. cooler temp fell below threshold x times in y hours), Time to corrective action, Door open and close frequency over defined time period, Max temperature swing over defined period of time, Average outside temperature, Temperature driven offer redemptions, Temperature driven rebate redemptions, Average inventory levels, Average temperature levels, Out of stock/low stock duration, Time from notification to issue rectification.

Individual notification triggers can be delivered via any or all of POS system, Tablet App, Smartphone (App, SMS), Smartwatch (App, SMS), Other wearable devices (E-mail, App, notification, SMS), Desktop PC (E-Mail, Web Landing Page), Laptop PC (E-Mail, Web Landing Page). General data may be distributed at the defined frequency, distributed based on a trigger or threshold being exceeded, and accessible any time in dashboard form via any or all of POS system, Tablet App, Smartphone (App, SMS link to Web landing), Smartwatch (App, SMS link to Web landing), Other wearable devices (E-mail, App, notification, SMS), Desktop PC (E-Mail, Web Landing Page), Laptop PC (E-Mail, Web Landing Page), or voice command system.

Additional data sources that are potentially relevant for the CPGs may include a POS system (consumer purchasing history). Potentially amended process/use cases for CPGs may include analyzing the propensity for loyal consumers to purchase or enter the store, as a function of temperature or cleanliness, are made available to the CPG (hence answering the question—how effective are automatic or sensor driven product offers or messages).

Consumers

The consumers may receive notifications for various situations. The notifications may be informational or may be in the form of coupons (e.g. digital coupons based on the captured sensor information). The determination to transmit the notification may be in the server 120 located in the store 110 and/or by the remote server 174. The consumers may receive notifications on a mobile or display device through a local network via server 120. The consumers may receive notifications on various devices through a wide area network via server 120 or remote server 174. Notifications may be triggered based on temperature events such as, temperature driven CPG offer is available, temperature driven CPG rebate is available, Cooler is at a target temperature, Heater/oven is at a target temperature. Further, notifications may be triggered based on cleanliness events such as, bathroom is vacant bathroom is busy.

Additional collected data from the sensors may be delivered at defined time/time interval(s) and analyzed for sending additional notifications or generating tasks. The product notifications may be based on exceeding a threshold (upper, lower, or based on a comparison) of one or more of a Rate of equipment in-spec/compliance, temperature driven CPG offer and rebate availability statistics. Cleanliness notifications may be based on exceeding a threshold (upper, lower, or based on a comparison) of one or more of last time bathroom was mopped/cleaned, average bathroom usage/throughput, general bathroom statistics (mop/clean rate, soap levels, paper towel/toilet paper inventory).

Individual notification triggers can be delivered via any or all of an Electronic LED, Tablet App, Smartphone (App, SMS), Smartwatch (App, SMS), Other wearable devices (E-mail, App, notification, SMS), Smart car infotainment (App, Alert). General data may be distributed at the defined frequency and accessible any time via any or all of an Electronic LED, Tablet App, Smartphone (App, SMS link to Web landing), Smartwatch (App, SMS link to Web landing), Desktop PC (E-Mail, Web Landing Page), Laptop PC (E-Mail, Web Landing Page), or voice command system.

Equipment OEMs

The equipment OEMs or repair services may receive notifications for various situations. The determination to transmit the notification may be in the server 120 located in the store 110 and/or by the remote server 174. The equipment OEMs or repair services may receive notifications on a mobile or display device through a local network via server 120. The equipment OEMs or repair services may receive notifications on various devices through a wide area network via server 120 or remote server 174. Notifications may be triggered based on events such as maintenance failure or work order request required, Toilet paper inventory is below defined threshold, Soap inventory is below defined threshold, Paper towel inventory is below defined threshold, Replacement mop head inventory is below defined threshold, Replacement mop inventory is below defined threshold.

Additional collected data from the sensors may be delivered at defined time/time interval(s) and analyzed for sending additional notifications based on a exceeding a threshold (upper, lower, or based on a comparison) of one or more of Average paper towel supply volume, Average toilet paper supply volume, Average soap levels.

Additional collected data from the sensors may be delivered at defined time/time interval(s) and analyzed for sending additional notifications based on a exceeding a threshold (upper, lower, or based on a comparison) of one or more of Average cooler temperature over defined time period, Average heater/oven temperature over defined time period, Number of notification triggers and their type (e.g. cooler temp fell below threshold x times in y hours), time to corrective action, door open and close frequency over defined time period, max temperature swing over defined period of time, coffee needs to be brewed, coffee machine is failing/failed, fountain drink cups are out of stock, hot dogs need restocking, CO2 tanks need replacement, general inventory restocking.

Individual notification triggers can be delivered via any or all of, Tablet App, Smartphone (App, SMS), Smartwatch (App, SMS), Desktop PC (E-Mail, Web Landing Page), Laptop PC (E-Mail, Web Landing Page). General data may be distributed at the defined frequency, distributed based on a trigger or threshold being exceeded, and accessible any time in dashboard form via any or all of Tablet App, Smartphone (App, SMS link to Web landing), Smartwatch (App, SMS link to Web landing), Desktop PC (E-Mail, Web Landing Page), Laptop PC (E-Mail, Web Landing Page), or voice command system.

The server 120 and/or server 174 includes communication interfaces 202, system circuitry 204, input/output (I/O) interfaces 206, and display circuitry 208 that generates user interfaces 210 locally or for remote display, e.g., in a web browser running on a local or remote machine through which a project is defined and resources are selected, evaluated, allocated, and connected to a project. The user interfaces 210 and the I/O interfaces 206 may include graphical user interfaces (GUIs), touch sensitive displays, voice or facial recognition inputs, buttons, switches, speakers and other user interface elements. Additional examples of the I/O interfaces 206 include microphones, video and still image cameras, headset and microphone input/output jacks, Universal Serial Bus (USB) connectors, memory card slots, and other types of inputs. The I/O interfaces 206 may further include magnetic or optical media interfaces (e.g., a CDROM or DVD drive), serial and parallel bus interfaces, and keyboard and mouse interfaces.

The communication interfaces 202 may include wireless transmitters and receivers (“transceivers”) 212 and any antennas 214 used by the transmit and receive circuitry of the transceivers 212. The transceivers 212 and antennas 214 may support WiFi network communications, for instance, under any version of IEEE 802.11, e.g., 802.11n or 802.11ac. The communication interfaces 202 may also include wireline transceivers 216. The wireline transceivers 216 may provide physical layer interfaces for any of a wide range of communication protocols, such as any type of Ethernet, data over cable service interface specification (DOCSIS), digital subscriber line (DSL), Synchronous Optical Network (SONET), or other protocol.

The system circuitry 204 may include any combination of hardware, software, firmware, or other circuitry. The system circuitry 204 may be implemented, for example, with one or more systems on a chip (SoC), application specific integrated circuits (ASIC), microprocessors, discrete analog and digital circuits, and other circuitry. The system circuitry 204 is part of the implementation of any desired functionality in the server 120 and/or server 174. As just one example, the system circuitry 204 may include one or more instruction processors 218 and memories 220. The memory 220 stores, for example, control instructions 222 and an operating system 224. In one implementation, the processor 218 executes the control instructions 222 and the operating system 224 to carry out any desired functionality for the server 120 and/or server 174. The control parameters 226 provide and specify configuration and operating options for the control instructions 222, operating system 224, and other functionality of the server 120 and/or server 174.

The server 120 and/or server 174 may include a local data repository 232 that includes volume storage devices, e.g., hard disk drives (HDDs) and solid state disk drives (SDDs). The storage devices may define and store databases that the control instructions 222 access, e.g., through a database control system, to perform the functionality implemented in the control instructions 222. In the example shown, the databases include a resource data database 228 and a project data database 230. In other implementations, any of the databases may be part of a single database structure, and, more generally, may be implemented logically or physically in many different ways. Each of the databases defines tables storing records that the control instructions 222 read, write, delete, and modify to perform the processing noted below. The resources descriptors may maintain their own resource descriptor data repositories. The system circuitry 204 may implement the resource analysis circuitry 114, project platform circuitry 116, and the operator control circuitry 118, e.g., as control instructions 222 executed by the processor 218.

The thresholds and alerts may be stored in one or more data bases and may be associated with the product or the product preparation unit or the product dispensing unit. For example, separate thresholds for each product characteristic such as temperature, humidity, and time may be stored for each product type in a product record. Separate thresholds for each product preparation or dispensing unit characteristic such as power (on, off, consumption), doors open/closed, temperature, humidity, time, amount of product contained, etc.; may be stored for each product preparation or dispensing unit type in a unit record.

Similar offers such as electronic coupons, in store advertisements or POS offers may be stored in records related to the product, the product preparation or dispensing unit, or a purchaser profile. Further, the offers may be generated and/or delivered in response to characteristics from or combinations of characteristics from the product, the product preparation or dispensing unit, and a purchaser profile. Redemptions of electronic coupons and or purchases corresponding with in store advertisements may be tracked and analyzed with respect to the characteristics (e.g. product temperature, ambient temperature, humidity, and other characteristics) that were used to generate and/or deliver the offer. As such, the usefulness of the offers may be maximized. This may even be controlled in a feedback loop where the thresholds are adjusted based on redemption data and/or purchase correlation data.

The thresholds and alerts may be stored in one or more data bases and may be associated with the sensor or device. For example, separate thresholds for each cleanliness characteristic may be stored for each sensor in a sensor record. Separate thresholds for characteristic of a device may be stored for each device in a device record.

Similar offers such as electronic coupons, in store advertisements or POS offers may be stored in records related to the sensor, or device (e.g. mop), or a purchaser profile. Further, the offers may be generated and/or delivered in response to characteristics from or combinations of characteristics from the sensor characteristic, device characteristic, and a purchaser profile. Redemptions of electronic coupons and or purchases corresponding with in store advertisements may be tracked and analyzed with respect to the characteristics (e.g. last bathroom cleaning, full toilet paper dispensers, paper towel dispensers) that were used to generate and/or deliver the offer. As such, the usefulness of the offers may be maximized. This may even be controlled in a feedback loop where the thresholds are adjusted based on redemption data and/or purchase correlation data.

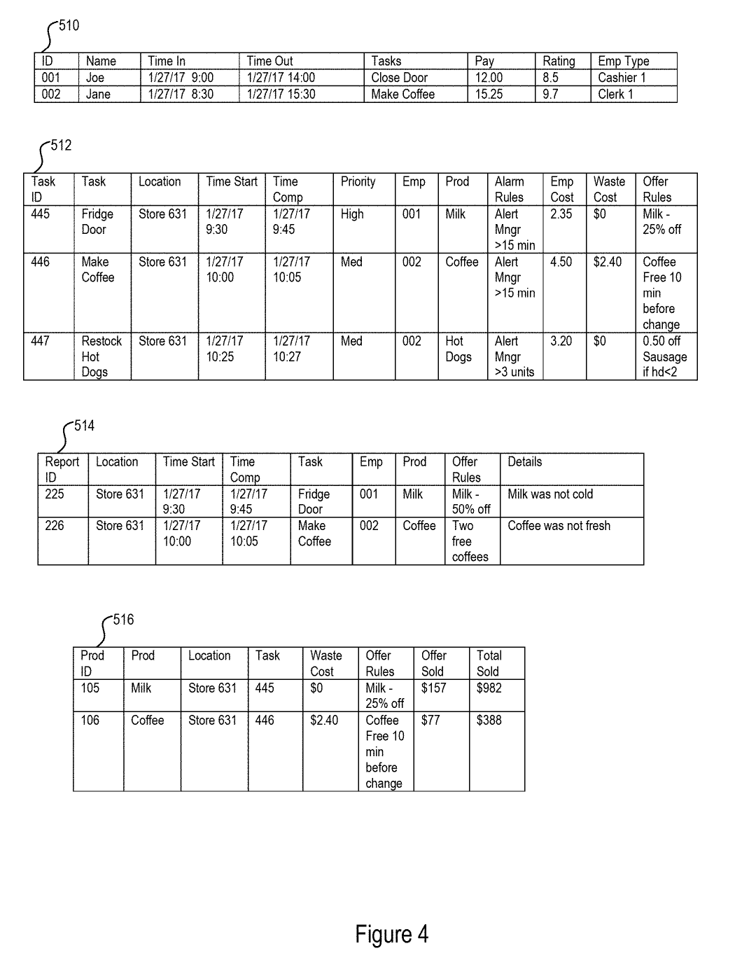

As noted above, the task monitoring system may include one or more databases. One example of the one or more databases is provided in FIG. 4. The one or more databases may include records for each employee. For example, the one or more databases may include a table 510 of records for each employee. The record for each employee may include fields such as an employee ID, a name, one or more time in entries, one or more time out entries, one more assigned tasks, a pay rate, a rating, an employee type.

The employee ID may be unique identifier for example a numeric or alpha numeric code. The one or more time in entries may be the times and/or dates that the employee enters the store or “clocks in” to work a shift. The one or more time out entries may be the times and/or dates that the employee leaves the store or “clocks out” of the shift. The time in entries and time out entries may be based on an radio frequency card or name badge, a mobile device (e.g. mobile phone, pda, music player), or punching in a time clock (e.g. with a time card or digitally, for example using a point of sale system). The tasks may be short projects (e.g. things to do or take care of) to keep the store running efficiently. The tasks may be scheduled or unscheduled tasks. Scheduled tasks may include short projects that are triggered by specific times or regular time intervals such as, cleaning the bathroom every hour, throwing out old coffee every 30 minutes, sweeping and mopping at specific times each day. Unscheduled tasks may include short projects that are triggered by some sensing or real time tracking mechanism. For example, closing a refrigerator door if the door sensor identifies it was left open, or the point of sale system requesting an employee to replenish hot dogs on the grill if a certain number have been sold over a given time interval.

The pay rate may be the amount of money the store pays the employee for a particular time interval (e.g. dollars per hour). However, the pay rate may include any overhead expenses, such as any benefits. Alternatively, a separate loaded rate could be provided that includes overhead. The employee rating is an indication of performance of the employee. The rating may include a composite number that covers all categories and separate ratings for particular categories (e.g. timeliness, customer service, etc.). The employee type may be a job title and may indicate that the employee has been trained to perform certain tasks. For example, a cashier may be trained to perform transactions with the POS system. A clerk may be trained to perform transactions with the POS system and also may perform certain types of food preparation such as putting hot dogs on the grill or making coffee.

A sub table may be formed for each employee that includes each task that was assigned to them for a given evaluation period. The rating for each employee may be calculated based on a function of the number of tasks, time to complete task, task priority, satisfaction scores related to the employee or their tasks. The task priority may provide an indication of the order in which the tasks are to be performed. The task priority may be based on many factors including other pending tasks, line queues (e.g. from a line queue monitor), or particular sensors inputs discussed elsewhere in this application. Satisfaction scores may be scores provided from consumers on a satisfaction report that are associated with a particular employee or a time period during which the employee worked. Satisfaction scores may be for satisfaction reports from managers or other teammates as well. The satisfaction score may include a composite number that covers all categories and separate ratings for particular categories (e.g. timeliness, customer service, etc.).

The one or more databases may include records for each task. For example, the one or more databases may include a table 512 of records for each task. The record for each task may include fields such as an task ID, task type, store location, time start, a time complete, an task priority, an employee assigned to an task, a product associated with the task, alarm rules for the task, employee cost, waste cost, and offer rules.

The task ID may be unique identifier for example a numeric or alpha numeric code that indicates a particular task. The task type may be the type of task from a predetermined list of categories (e.g. cleaning, stocking, food preparation, etc.). The task type may be matched to a job description of an employee type who is currently working. If the task type does not match with an employee type currently working an alert may be generated (e.g. to the store manager). The store location may be an unique identifier that indicates the particular store for which the task is generated, for example a unique numeric or alpha numeric code.

The time start is the time and/or date that the task was initiated or that notification was provided to the employee. The time to complete may be the time that was taken to complete the task or the time taken so far if the task is not yet completed. The task priority may provide an indication of the order in which the tasks are to be performed. The task priority may be based on many factors including other pending tasks, line queues (e.g. from a line queue monitor), or particular sensors inputs discussed elsewhere in this application.

The employee assigned to the task may be responsible for completing the task, the assignment of the task to the employee may be based on the number of tasks assigned to that or other employees, the qualifications of the employee, the priority of the task, etc. Further, the system may assign tasks based on the rating assigned to an employee and may assign tasks based on previous tasks completed or satisfaction scores related to a particular type of task.

The product associated with the task may be based on information from the point of sale system, or based on a sensor being associated with a particular product or equipment within which the product is housed (e.g. the milk refrigerator, the hot dog grill, frozen drink machine, fountain drink machine). The alarm rules may be based on the type of task, the product, or the type of machine associated with the task. For example, alert a manager or a store employee if the fridge door has been opened longer than a specified period of time. In another example, alert a manager or a store employee for restocking if fewer than a threshold number or amount of a product is available for purchase.

The employee cost may be the cost of having a particular employee perform the task based on factors such as the pay rate of that employee, the time taken to complete the task, and/or other entries described above. The waste cost may be the amount of product that has to be discarded based on the task. In one example, if the hot dogs have been on the grill for over an hour the task may instruct the employee to throw out old hot dogs and put on new ones. In another example, if the milk fridge is left open for an extended period and the temperature falls below a certain threshold, milk will need to be disposed of and the cost of the product that is wasted can be included. Offer rules may be offers that are generated and displayed in the store or sent to customers. The offer rules may be based on the task, type of task, the product, the type of machine associated with the task, other related products available in the store, etc. In one example, consumers may be offered discounts on an item where the fridge door is open or a temperature is out of range. In another example, consumers may be offered discounts on an item where it is reaching an expiration time or restocking time. In another example, a discount can be offered on a related product if a particular product is not available or is in low supply (e.g. below a threshold).

Some tasks may be tasks that are generated based on sensor input, for example, a refrigerator door is open. Some tasks may be generated based on a timer, for example, coffee may be thrown out if it is more than one hour old. Some tasks may be generated based on point of sale information, for example, restocking a particular product like hot dogs on the grill. A task may be generated based on any of the alerts or notifications described throughout this notification. The task may be to fix the deficiency or error related to the alert or notification. Alternatively, the task may be to provide certain offers or incentives.

A sub table 516 may be formed for each product that includes records for each task that was associate with the product for a given evaluation period. Each record may include the product, each task, the waste, any offers generate, the number of units sold. The waste may be a cost or number of the product that is not sold but for example must be discarded due to expiration or employee error. The table may track the number of units and/or the amount sold. Further, the offers that are generated may be tracked which provide discounts to consumers. In addition, profitability for a product may be determined for each unit of the product based on the above and other factors. A rating may be generated for each product indicating the profitability for each product for a particular location, or group of locations. The rating for a product may be calculated based on a function of the number of tasks, waste, offers, and units sold.

The one or more databases may include records for customer satisfaction. For example, the one or more databases may include a table 514 of records for each customer satisfaction report. The record for each customer satisfaction may include fields such as a satisfaction report ID, a store location, satisfaction score, time associated with the report, tasks associated with the report, employees associated with the report, details, offer rules.

The satisfaction report ID may be unique identifier for example a numeric or alpha numeric code that indicates a satisfaction report. The store location may be an unique identifier that indicates the particular store for which the task is generated, for example a unique numeric or alpha numeric code. Satisfaction scores may be scores provided from consumers on a satisfaction report that are associated with a particular employee or a time period during which the employee worked. Satisfaction scores may be for satisfaction reports from managers or other teammates as well. The satisfaction score may include a composite number that covers all categories and separate ratings for particular categories (e.g. timeliness, customer service, etc.). Time associated with the satisfaction report may be used to determine the time frame to which the report is related. The time frame may be used to match tasks to the report using the task start or complete time. The time frame may be used to match employees to the report based on time in and time out entries. Various detail entries may be available allow the user to expand on their experience and may be used for human interpretation of the experience. Additionally, offer rules may be attached to the satisfaction report to provide discounts to consumers based on the satisfaction report. For example, if the consumer purchased coffee was not fresh, the consumer may be offered two free coffees and be asked to report their satisfaction with future purchases.

FIG. 6 is an illustration of a display device for a task monitoring system. The device 610 may be any one of the notification devices mentioned throughout this application, including any or all of POS system, Tablet, Smartphone, Smartwatch, Other wearable devices, Desktop PC, Laptop PC, etc. The display may include a list of tasks 614 to be completed. The tasks may be clickable, for example, links may be provided that display more information about each task. The display may include a list of instructions 612 on how to complete the task. The display may by default show the current task (e.g. first on the task list). However, directions may be switched to any task that is selected from the task list. The display may include a map 616 indicating the location of one or more tasks to be completed. In one example, only the current task location is marked with an indicator. In other implementations, different indicators may be used for the location for each task. In one example, the location may be marked with a number corresponding to the task number. For example, making coffee is the current task, for example, the first task on the list. As such, the instructions for making coffee may be displayed on the screen and the location of the coffee maker is marked on the map. The second task is to close the refrigerator door, as such the refrigerator that needs to be closed is marked on the map. The indicators may be overlaid on one or more pictures of the actual store in which the employee is working, thereby simplifying and clarifying the task for the employee. The employee may be logged into the device or application such that the map, tasks, or instructions may be those specifically related to the employee that is currently logged in.

The system may also include a microphone 622 and speaker 624 for voice command operation. The microphone 622 and speaker 624 may be integrated into a wearable headset assembly 630. Alternatively, the microphone 622 and speaker 624 may be in a small counter top assembly 620. In another example, the speaker and microphone may be utilized in a personal mobile device, such as a tablet, mobile phone or portable music player. The store clerk may receive instructions via automated verbal commands generated in response to tasks in the database. Further, verbal responses may be provided by the store clerk through the microphone, for example, using voice recognition technology. The particular store clerk may be identified by a device being used by the store clerk. For example, the store clerk may be logged into an application on that device, e.g. the clerk's mobile phone. In some instances, voice messages may be provided to the clerk through the speaker and the clerk may respond through an user interface on the display device. Any of the devices mentioned above may be in communication with the server 120 or server 174 to receive or transmit voice messages related to generated tasks.

As such, the system may send a broadcast message to multiple employees reporting a task to be completed. The system may determine who issues a voice response to accept the task by either determining which device (e.g. logon) responds or by performing voice recognition to identify the voice of the clerk. In another example, the system may select a clerk to which the task is assigned and generate a voice message to the particular clerk to which the task is assigned. The system may then wait for a voice response from the clerk to which the task is assigned whether the task is accepted or rejected. If the task is rejected or a response is not received within a given time period, the system may reassign the task to another clerk. If the task is accepted, the system may also wait for a voice response when the task has been completed. The system may also request statistics, such as quantity or type information, or maintenance information. The clerk may provide any requested information, but may also issue a help or assistance command to generate a task for a store manager or a service provider (such as a maintenance person).

In one example, the system may generate a voice command in response to a task to make a new pot of coffee. The clerk may speak a voice response that the task is accepted, which is received by the system processor. The processor may wait for a voice response from the clerk that the task is complete (e.g. the coffee has been made). If the task complete response is not received within a given time period, the processor may issue a verbal reminder to the clerk to which the task is assigned. In some instances, each step in the directions may be verbally provided through the speaker. The clerk may confirm completion after each step before the next step is read. Additional commands like repeat may be used to verbally provide the last instruction again.

In some instances, voice messages may be generated in response to tasks. In one example, the voice message may be an offer to a consumer. For example, after a task has been completed to make coffee, a voice message may be generated offering a discount to a consumer through an app on their phone or through a speaker mounted on or near the coffee machine. The message may say “please have a fresh cup of coffee, brewed only two minutes ago.” Further, the message may be generated in response to customer profile information, if the system senses the identity or location of a consumer within the store (e.g. through a loyalty app). In some instance, the message may be provided to the clerk instructing the clerk to offer a discount on the coffee based on the task or consumer profile information. Similarly, the system may remind (e.g. verbally through the speaker or through the display) the clerk of a consumer name and/or rewards status based on the profile information, so that the clerk may appropriately greet the consumer by name and thank them for their loyalty in relation to their rewards status.

In another example, the voice message to the consumer or clerk may be based on maintenance or appliance information. For example, “please try coffee from our new coffee maker at a 50% discount.” In another example, an OEM manufacturer or maintenance person may provide maintenance information during repairs. For example, the system may request and the maintenance person may provide information about cleaning, what parts are replaced, appliance up time, appliance down time, cause of failure, etc.

The store clerk and delivery person may use voice commands to verify and reconcile inventory information. The delivery person may speak the amount of each item delivered. The clerk can also speak the amount of inventory delivered and may speak the amount left on the shelf. This information may be used to verify inventory information (e.g. for ordering and POS tracking) and may be used reconcile bill for the delivered items with the product supplier.

The methods, devices, processors, modules, engines, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

As a person skilled in the art will readily appreciate, the above description is meant as an illustration of implementation of the principles this disclosure. This description is not intended to limit the scope or application of this system in that the system is susceptible to modification, variation and change, without departing from the spirit of this disclosure, as defined in the following claims.

I/We claim:

1. A system for monitoring personnel tasks in a store, the system comprising:
at least one sensor configured to measure product or cleanliness characteristics in the store; and
a processor in communication with the at least one sensor and configured to assign a task to an employee based on a measurement from the at least one sensor.

2. The system of claim 1, wherein the processor is configured to assign the task to the employee based on an employee type that is approved for the task.

3. The system of claim 1, wherein the processor is configured to verify completion of the task based on the at least one sensor.

4. The system of claim 1, wherein the processor is configured to receive an input indicating the task has been accepted by the employee.

5. The system of claim 1, wherein the processor is configured to receive an input indicating the task has been completed by the employee.

6. The system of claim 1, wherein the processor is configured to acquire a quality feedback related to the task based on the sensor.

7. The system of claim 6, wherein the processor is configured to acquire a quality feedback related to the task based on consumer satisfaction report.

8. The system of claim 6, wherein the processor is configured to generate a notification to a store manager if the quality feed is below a quality threshold level.

9. The system of claim 1, wherein the processor is configured to track an amount of time taken to start the task.

10. The system of claim 9, wherein the processor is configured to generate a notification to a store manager if the amount of time is greater than a time threshold.

11. The system of claim 1, wherein the processor is configured to track an amount of time used to complete the task.

12. The system of claim 11, wherein the processor is configured to generate a notification to a store manager if the amount of time is greater than a time threshold.

13. The system of claim 11, wherein the processor is configured to generate a rating for the employee based on the amount of time.

14. The system of claim 1, wherein the processor is configured to generate a map that indicates a location within the store related to the task or sensor.

15. The system of claim 14, wherein map includes a picture of the store where the task is to be performed.

16. The system of claim 1, wherein the processor is configured to generate a list of instructions for performing the task.

17. A system for monitoring tasks in a store, the system comprising:
a database storing data related to products or cleanliness in the store;
a processor in communication with the database and configured to:
generate a task automatically based on data stored in the database;
assign the task to an employee based on the data; and
determine that the task has been completed.

18. The system of claim 17, wherein the task is generated in response to a sensor monitoring product characteristics or cleanliness characteristics in the store.

19. The system of claim 17, wherein the processor is configured to verify that the task has completed based on the sensor.

20. The system of claim 17, wherein the task is generated based on a time interval or a prescheduled time.

21. A system for monitoring personnel tasks in a store, the system comprising:
a microphone configured to receive voice messages or a speaker configured to generate voice messages; and
a processor in communication with the microphone or speaker and configured to track a task assigned to an employee utilizing the voice messages.
